(19) United States
(12) Patent Application Publication
(10) Pub. No.: US 2006/0155571 A1
(43) Pub. Date: Jul. 13, 2006

(54) Automated, multiple order generation to vendors and creation of alerts and reminder using single entry of walkthrough data

(76) Inventors: Jess Almeida, Pleasanton, CA (US); Kamlesh Amin, San Jose, CA (US); Severo D'Souza, San Jose, CA (US); Cyril Mecwen, Saratoga, CA (US); Koustubh Naik, Pune (IN); Anoop Tewari, San Jose, CA (US)

Correspondence Address: Jess Almeida, 1549 Whispering Oaks Way, Pleasanton, CA, 95466, US

(21) Appl. No.: 11/328,940

(22) Filed: Jan. 10, 2006

Related U.S. Application Data
(60) Provisional application No. 60/643,450, filed on Jan. 13, 2005.

(51) Int. Cl. G06Q 99/00

(52) U.S. Cl. 705/1

(57) ABSTRACT

The present invention property walkthrough results in a complete survey of the house with all the appropriate vendors contacted for preparing the house for listing. The present invention method and system comprises online/offline walkthrough forms that allow the agent to conduct a walkthrough, which, at the end, automatically results in order creation for vendors. Using an existing vendor profile, vendors for respective property related tasks such as property inspection, maintenance, verifications of permits, are notified. Further, alerts and reminders are also setup automatically to ensure the handling of contingencies.

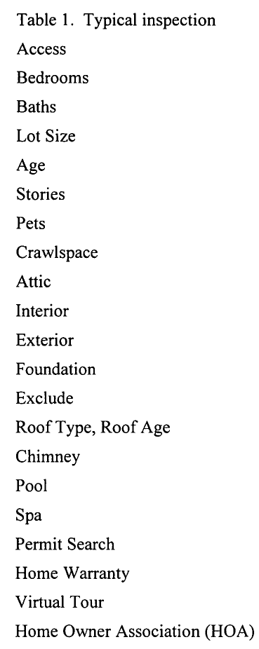

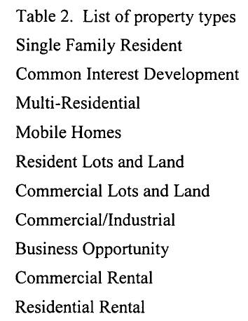

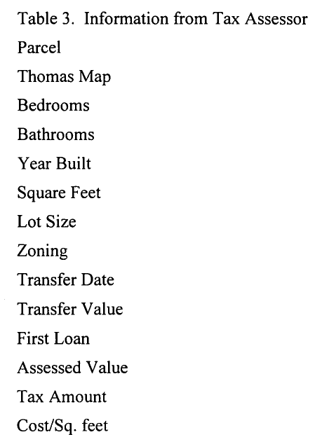

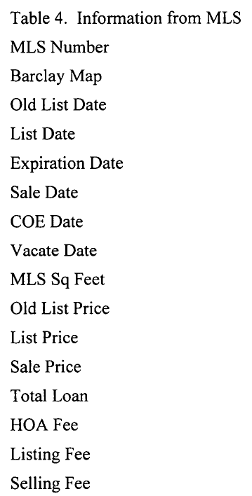

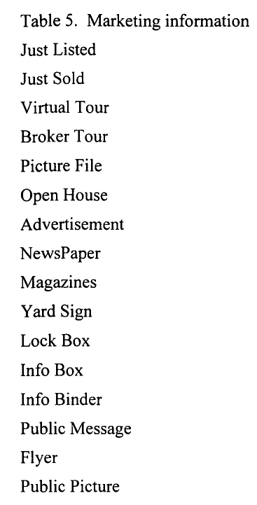

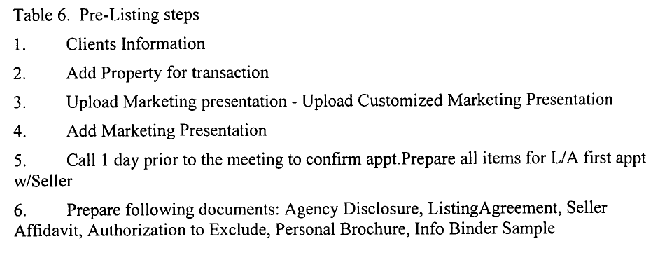

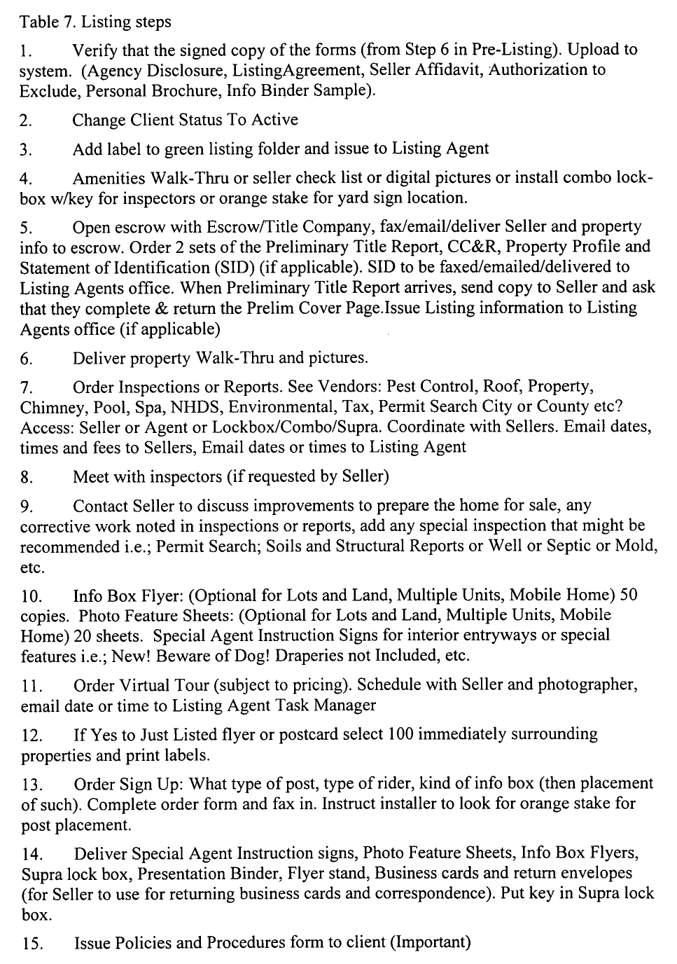

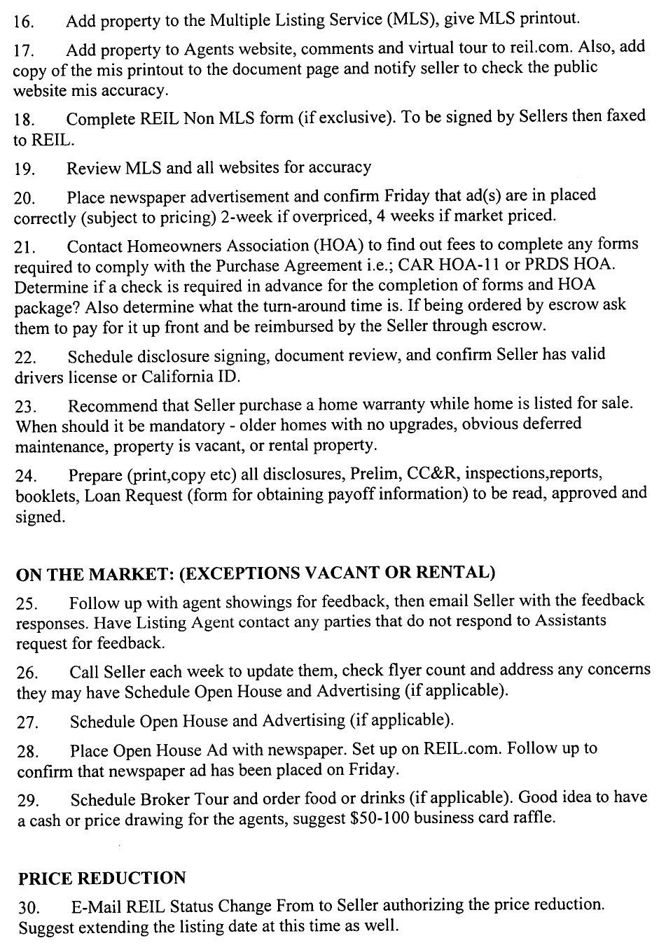

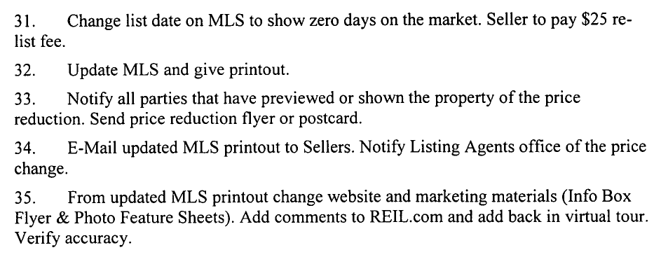

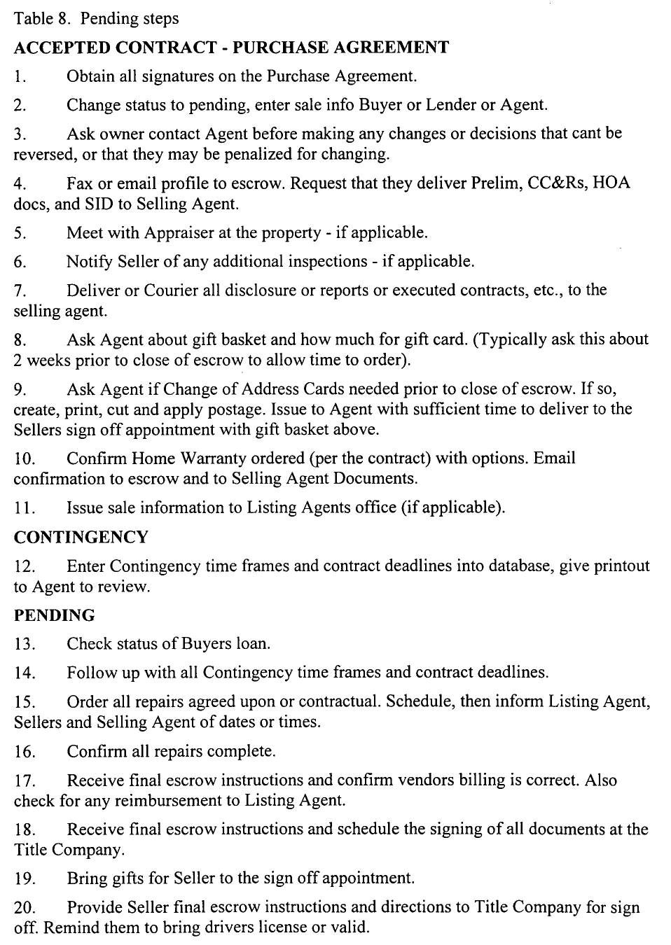

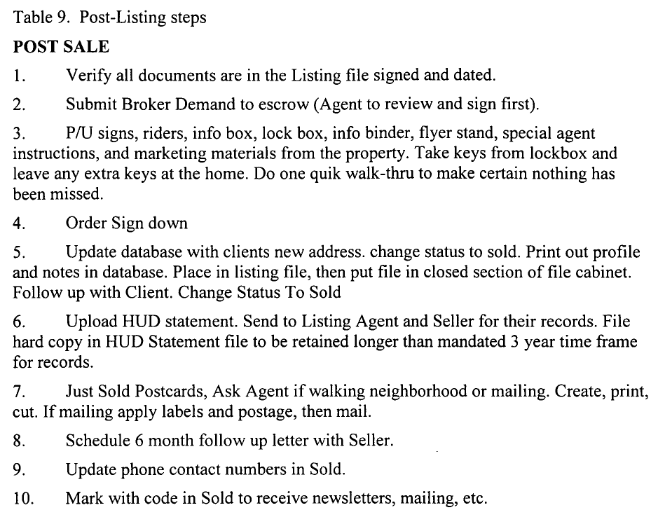

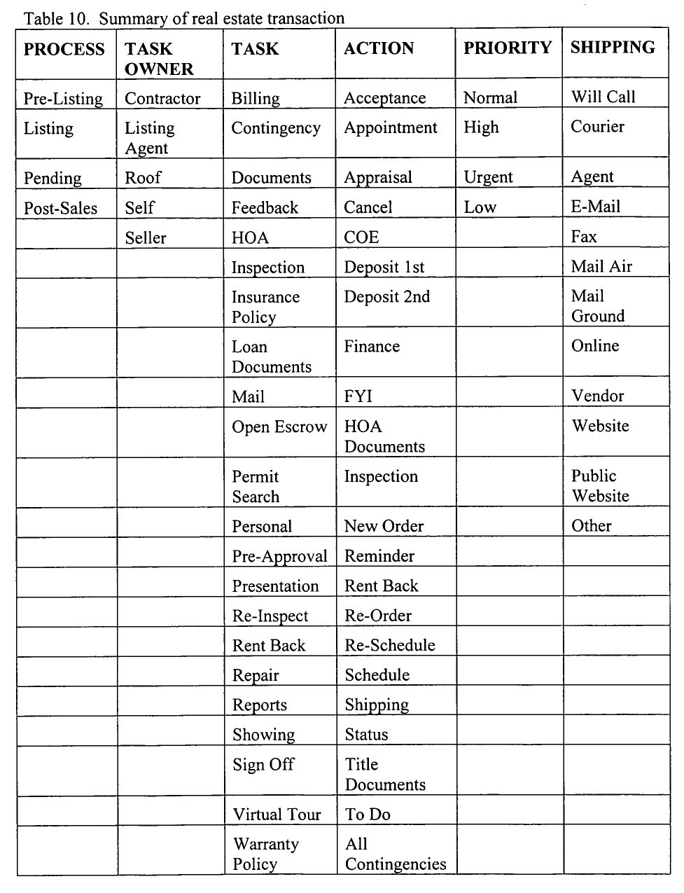

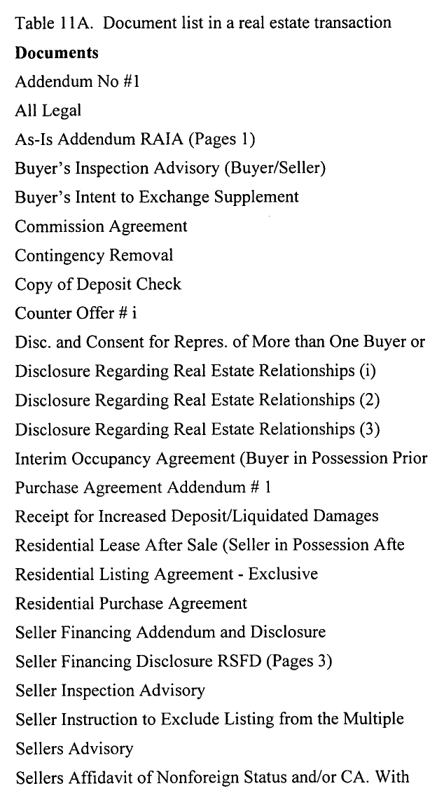

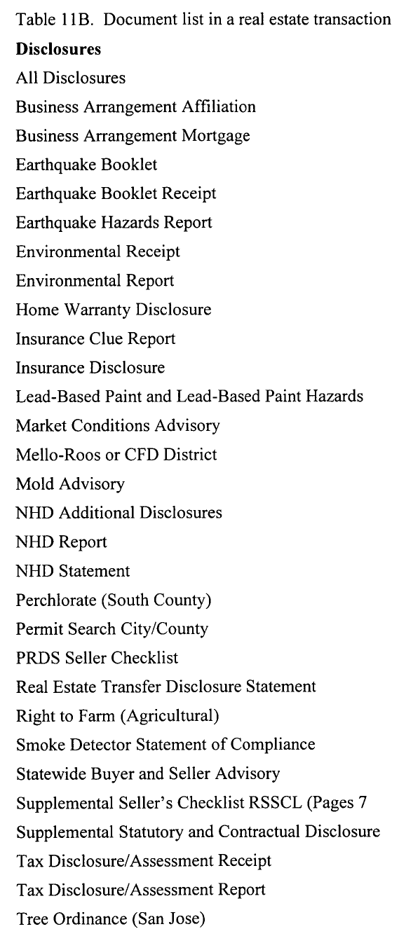

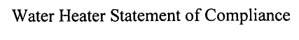

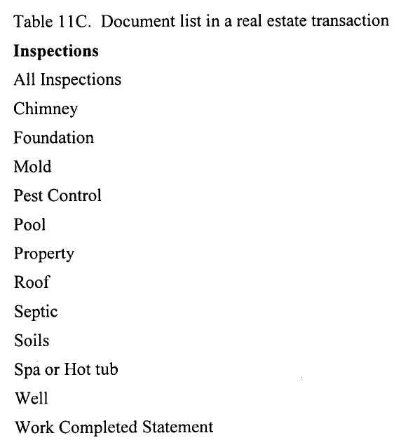

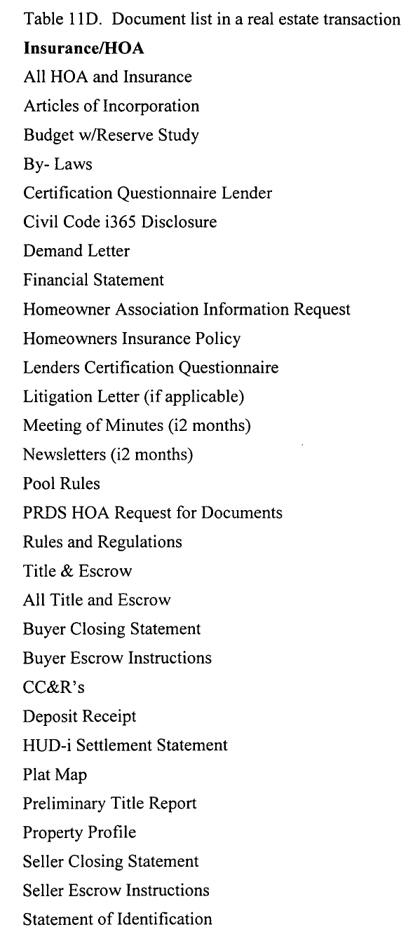

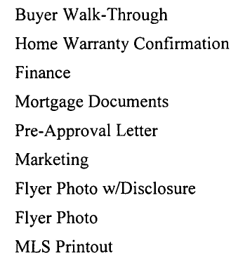

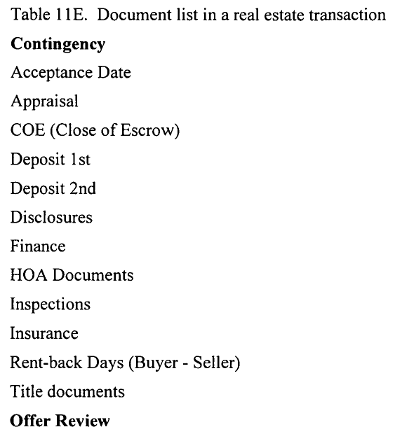

This application claims priority from U.S. provisional applications Ser. No. 60/643,450 filed Jan. 13, 2005, entitled “Automated, Multiple Order Generation to Vendors and Creation of Alerts and Reminder using Single Entry of Walkthrough Data” which is incorporated herein by reference.

### FIELD OF THE INVENTION

This application is related to a real estate transaction, and particularly to a simplied and effective method and system to perform real estate services.

### BACKGROUND OF THE INVENTION

Every real estate transaction involves the creation and exchanges of multiple documents between multiple parties, including buyer, seller, their respective agents, brokers, and agencies and various service providers such as financial institutions (e.g., mortgage lenders and underwriters), escrow companies, title companies, insurance companies, construction companies, advertising companies, architects, property inspectors, appraisers, attorneys, property managers, aerial photographers, property photographers, governmental agencies (e.g., county clerk, deed recording).

Thus the aggregation and control of document repository in a real estate transaction are critical due, at least in part, to the number of participants in a transaction and the numerous documents involved, ranging from information disclosure to many needed work completions, and to the constant exchanged, revised and updated actions between multiple parties. There is a need for accurate and complete documentation since the real estate transaction is probably the most expensive purchase of a buyer and it is governed by much rules and regulations.

One requirement of the listing agent is a property walkthrough. Agent is required to walkthrough and inspects the property before the property may be sold. During this process the agent takes pictures of property and takes notes related to the state of the property.

### SUMMARY OF THE INVENTION

The present invention property walkthrough results in a complete survey of the house with all the appropriate vendors contacted for preparing the house for listing. The present invention method and system comprises online/offline walkthrough forms that allow the agent to conduct a walkthrough, which, at the end, automatically results in order creation for vendors. Using an existing vendor profile, vendors for respective property related tasks such as property inspection, maintenance, verifications of permits, are notified. Further, alerts and reminders are also setup automatically to ensure the handling of contingencies.

The present invention discloses an integrated method for integrating a required property walkthrough for the inspection of the property to be sold with appropriate actions and documents needed to prepare the property for listing. The method comprises an automated generation of orders for property-related tasks during the property walkthrough, thus at the end of the walkthrough, needed actions and documents for preparing the property for listing are completed. The method further comprises an automated creation of alerts and reminder during the property walkthrough for keeping track of the orders. The automated order generation is accomplished through wireless communication to a central server, through checking a prepared checklist, or through filling an order form. The order generation is to contact a vendor for performing the work, to contact a vendor for requesting a quote, or to contact a seller for requesting information.

### BRIEF DESCRIPTIONS OF THE DRAWINGS

Table 1. Typical inspection and billing.

Table 2. List of property types.

Table 3. Information from Tax Assessor.

Table 4. Information from MLS.

Table 5. Marketing information.

Table 6. Pre-Listing steps.

Table 7. Listing steps.

Table 8. Pending steps

Table 9. Post-Listing steps

Table 10. Summary of real estate transaction

Table 11A. Document list in a real estate transaction—Documents

Table 11B. Document list in a real estate transaction—Disclosures

Table 11C. Document list in a real estate transaction—Inspections

Table 11D. Document list in a real estate transaction—Insurance

Table 11E. Document list in a real estate transaction—Contingency and Offer review

### DETAILED DESCRIPTION OF THE INVENTION

Table 1 lists a typical overview inspection area for a real estate transaction according to the present invention. This list can serve as a template for checklist, to ensure the completeness of the inspection.

Table 2 lists the property types in a typical real estate transaction. The present invention allows for the branching of decisions based on property type. The input of the property type can be manually entered, or can be automatically received from Tax Assessor record, or from MLS record.

Table 3 and 4 list the information that a Tax Assessor or a MLS (Multiple Listing Service) can provide. This information can be used for decision branching in the present invention.

Table 5 lists the information needed for marketing a real estate property.

Table 6 lists the steps according to the present invention prior to the listing of a property. Table 7 list the steps according to the present invention for the listing of a property, following the pre-listing steps. The listing steps further includes the steps for putting the property on the market, and the optional steps of reduction in price. Table 8 lists the steps for a pending action, after receiving an offer. Pending steps includes the steps of review the offer, steps for contingency action, and the pending actions. Table 9 lists the steps for the Post-Listing, after selling the property.

Table 10 lists a summary of the real estate transaction, including the processes, the task owners, the tasks, the actions, the priority and the shipping actions.

Tables 11A-E list the documents in a real estate transaction, in which Table 11A lists the documents, Table 11B lists the disclosures, Table 11C lists the inspection documents, Table 11D lists the Insurance and Home Owner Association (HOA) documents, and Table 11E lists the contingency documents and offer review document.

The present invention discloses a method and system comprising online/offline walkthrough forms that allow the agent to conduct a walkthrough, which, at the end, automatically results in order creation for vendors. Using an existing vendor profile, vendors for respective property related tasks such as property inspection, maintenance, verifications of permits, are notified. Further, alerts and reminders are also setup automatically to ensure the handling of contingencies.

This innovative system provides the methodology and tools to integrate the required walkthrough with all the needed property actions. In the preferred embodiment, during the walkthrough, agent is equiped with wireless communication to a server. The server provides predetermined templates, suggesting the course of actions. For example, the templates ask to look for any new addition to the house, the number of rooms, the conditions of the house, the lights, or the faucets. The server then further suggests a series of actions resulting from the inputs from the agents during the walkthrough. For example, by answering that there is a new addition to the house, the server will launch a house addition section, where further questions are asked and actions taken. The server will ask for more information, such as where is the addition, what kind of addition, the year built, the condition of the addition, and the permit. Based on the answers, again the server will launch into an action section where requests for work are sent. For example, if there is a house addition with a permit, the server will contact appropriate vendor for the verification of permit. If the house addition condition is poor and needed repair, appropriate vendors are also contacted. The vendors are selected from a list of vendors that the server keeps in its database. The server's actions are predetermined in a default list, and are also marked with overridden capability. For example, if there is a house addition with a permit, the default setting would be asking if a verification of permit is needed. Other setting would be that a permit verification is always needed, and the server proceeds directly to the next step of contacting the vendor for permit verification. The server also keeps track of the requested actions, and thus generates alerts and reminders to ensure that these actions are performed per specifications.

The end result of the present invention walkthrough is a complete survey of the house with all the appropriate vendors contacted for preparing the house for listing.

The present invention is directed to a system that satisfies the need for a real estate transaction management system which completely integrates the walkthrough with all actions and documents needed to prepare the house for listing. In an preferred embodiment, the system comprises a server, executing software stored in a hard drive and thereby provides a plurality of templates within the real estate transaction management system. The document templates can be accessed using the remote computers, preferably wireless, connected to the server via the Internet. The document templates include the collections of documents and information designed for a particular user of the real estate transaction management system. The document templates further include context help and guided directions to mitigate the brokers' risk, to ensure that all needed information is provided and not missed.

In an embodiment of the present invention, the agent takes the walkthrough form and goes over the check list as he/she walks through the property. The walkthrough form contains information whose results are inputs for task manager for vendors, agents, buyers and seller. Depending on the feature available in the property, inspection requests are triggered and tasks are created that generate reminders for completing the inspections.

Depending on the type of inspection, approved vendors are automatically selected and notified over the preferred mode of communication such as email or fax. This may result in the request of quote or placing of the order depending on the configuration in the vendor profile. For example, for the vendors for which the terms and business relationship is already established, an order may be place directly.

During the property walkthrough, if it is observed that certain home improvement activity is required, making such entries in the walkthrough form automatically generates notification to appropriate home improvement vendor or vendors. If certain home improvement activities have occurred, automatic alerts is created to solicit permits and to produce disclosures. This also results in the creation of tasks that generate alerts and reminders. The agent, during the walkthrough, can also equiped with a camera or video camera to take pictures. Any pictures, still or movie, taken during the walkthrough, once submitted to the system in digital still, stream-able, or downloadable format; make their way to the media library for the use in design center. This multimedia content is automatically made available to agent and collaborating parties to be used in the creation of marketing collateral. This may be used during the sale of the property and in the after sale lead generation activity.

The walkthrough form allows user to add data manually online and offline, or through different sources such as multiple listing service (MLS), Dataquick Company or other website locations. The information is saved in a format that can be viewed online and offline. This form can be printed, faxed or emailed to facilitate taking notes using traditional (ink and paper) system, yet once the data (from the form) is transferred to the host system, it initiates various automatic activities.

The present invention walkthrough concept is a single action with multiple ordering system concept with built-in alerts and reminders to help automate and guide the end user through the process. The walkthrough is a combination of the property page, task manager, photo feature sheet, transfer disclosure statement, agent's visual walkthrough, home improvement checklist and vendor checklist. It also includes alerts and reminders. Once the walkthrough is initiated, any number of actions may happen without user involvement.

The system further includes blank walkthrough forms, samples of completed walkthroughs, or detailed instruction on how to use the forms most effectively.

The system further introduces discipline and mitigates the brokers' risk by providing guided questionaires for necessary situations during the walkthrough. The walkthrough form includes all documentation related to real estate transaction, and further elucidate the user with examples, explanations, and guided prompts. The system guides the user with questions to ask, with situations to look for, and with documentation to prepare. The system further allows the tuning of the step-by-step process itself to accommodate individual broker methodology. Scheduling feature is also included for proper timing and coordination of the transaction.

The present invention specifically has been applied to online system for the purpose of transacting a purchase or sale of a real estate property with various specifications.

The customer (agent or broker) has the ability to override or tailor the process to their using the recommendation generated by the system. The modification, for example, Flip the check list and start at different step, may be “permanent” in nature, where the agent will always use the same procedure or may be “temporary” and applied only to this transaction. Systems knowledge of the exact step of a transaction provides for risk management capabilities for each step. Missing documents or transaction data in earlier steps gets flagged resulting in automatic alert generation. Alert system then automatically notifies the involved parties of the status of a document, and the status it should be, and alert the party that the document is “behind” for a given step in every step of the process.

The present invention transaction method includes context based guidance to help reduce the errors and omissions. The system enforces an improvement in overall quality of transaction data being captured. Online system maintains and provides status of steps and alerts, anytime and anywhere.

The system can also provide a step-by-step method with guided questionaires for improving the quality of the walkthrough. The method comprises a predetermined series of steps related to a real estate transaction wherein each step comprises a plurality of choices with selected default choices and a selection wherein an user can choose to skip this step, to jump to a chosen step, to override the default choices, to modify the default choices temporarily, to modify the default choices permanently, to update the documents, to prompt for the a documents to be submitted, to have guided choices to ensure that an user not missing a step or a detail, to have guided conversation tool to ensure that an user not missing a question to ask, to have conversation logs and email trails, to have message templates to encourage agent to document the transaction, to have electronic communications by message helper for providing context sentitive message, to automatic alert system for missing transaction data or document and to automatic alert system for behind for a given step.

The invention uses a database to minimize the risk involved in the preparation of all services and documentation needed for real estate closings. Information input into the database is used to generate the documentation necessary to complete real estate transfers, including all forms required by relevant financial institutions and government agencies. Context help and guided questionaires are included to ensure completely and accurately preparing the documentation. Further included are scheduling features for coordinating the many tasks of a real estate transaction.

The provided walkthrough form comprises various templates that conform to the functionality of the transactions. Preferably, the templates are grouped according to the time line of the transaction. The templates can also grouped according to categories, such as transaction types, party types and service types. The transaction type templates include the forms that are available for a real estate transaction, with the prompting for the core transaction data pertaining to a particular transaction. The party type templates include the forms related to the parties in a real estate transaction, with the prompting for the data pertaining to a particular party. For example, the prompting asks for pets, and for specific instructions regarding pets, to address the case that an owner may have an indoor cat which continually tries to go out of doors. The service type templates include the forms related to the services which can be ordered. There are linkages between the templates with prompting to lead from one template to another.

There are schedule work for the service providers, for example, the inspection of the property, a verification of clear title, and a satisfactory appraisal of the value of the real estate. Further, the invention provides a data resource of suppliers of products and services in a real estate transaction, such as appraisal service, property photographers, home repair and maintenance services, home inspectors, general contractors, interior/exterior decorators, landscapers, school districts, etc.

An on-line property management environment comprises a distributed computer network, such as the global Internet, coupled to numerous service providers, a property services server platform connected to a local database, and numerous property information databases. The service providers server represent typical service providers of property services for servicing the activities in the property management field. For example, typical property services accessible include house repair, landscape service, appliance repair.

Property services server is prepared with a database containing the address, the contact name for different services. The database of service providers is preferably the result of past services, having referral and credibility already verified to ensure reliable services.

Similarly, engineering services and environmental services can be provided, especially in commercial real estate transaction. Preferred engineering services include a property condition report, providing the agent with information relating to structural integrity of buildings and the like or estimates of build-out costs or costs of refitting the structure for specific commercial needs. Preferred environmental services include services relating to diferrent levels of risk assessments related to contamination.

The walkthrough process is the process of learning about the property, and can sometimes called due diligence. Due diligence services include services to obtaining information of the property, verifying the ownership, property boundaries, existence of liens or encumbrances, tax status, condition of the property, value of the property, and environmental contamination.

A method to improve real estate transactions, the method comprising the steps of performing a walkthrough to inspect a real estate property; going over a real estate transaction checklist during the walkthrough; and triggering actions related to the real estate transaction by marking on the checklist. The real estate transaction checklist can include property inspection locations; home improvement locations; verification of existing permits; and photo feature location. The marking of a property inspection location on the checklist triggers the actions of selecting and notifying approved vendor; requesting for quote or placing order; and generating reminder. The marking of a home improvement location on the checklist triggers the actions of selecting and notifying approved vendor; generating alert for solicit permit; generating alert for producing disclosure; requesting for quote or placing order; and generating reminder. The marking of a permit verification on the checklist triggers the actions of selecting and notifying approved vendor; requesting for quote or placing order; and generating reminder. The marking of a photo feature location on the checklist triggers the action of transferring the photo to a real estate transaction data folder.

What is claimed is:

1. An integrated method for integrating a required property walkthrough for the inspection of the property to be sold with appropriate actions and documents needed to prepare the property for listing, the method comprising an automated generation of orders for property-related tasks during the property walkthrough, wherein at the end of the walkthrough, needed actions and documents for preparing the property for listing are completed.

2. A method as in claim 1 further comprising an automated creation of alerts and reminder during the property walkthrough.

3. A method as in claim 1 wherein the creation of alerts and reminder is generated from keeping track of the orders.

4. A method as in claim 1 wherein the automated order generation is accomplished through wireless communication to a central server.

5. A method as in claim 1 wherein the automated order generation is accomplished through checking a prepared checklist.

6. A method as in claim 1 wherein the automated order generation is accomplished through filling an order form.

7. A method as in claim 1 wherein the order generation is to contact a vendor for performing the work, to contact a vendor for requesting a quote, or to contact a seller for requesting information.

8. A method as in claim 1 wherein the property-related tasks are property disclosure, property service, property inspection, property maintenance, property repair, property picture taking, property video taking and verifications of permits and title.

9. A method as in claim 1 wherein the property disclosures are transfer disclosure statement, school district disclosure, ownership disclosure, lien or encumbrance disclosure, and property boundary disclosure.

10. A method as in claim 1 wherein the property services are interior and exterior decorator service, landscape service, property condition report, and property contamination report.

11. A method as in claim 1 wherein the property repairs are house repair, lawn repair, and appliance repair.

12. An integrated method for simplying real estate transaction during a preparation of a property for listing, the method comprising
performing a property walkthrough for inspection of the property;
generating orders for property-related tasks during the property walkthrough using existing vendor profiles.

13. A method as in claim 1 further comprising a step of a preparing a set of predetermined templates for suggesting a course of actions during the property walkthrough.

14. A method as in claim 1 further comprising a step of inputting a condition of the property during the property walkthrough to get a suggestion of a series of actions.

15. A method as in claim 1 further comprising a preparing step of practicing through blank walkthrough forms, thrpugh samples of completed walkthrough, or through detailed instruction of how to use the walkthrough forms.

16. A method as in claim 1 further comprising a database of service providers for the property, wherein the service providers are contacted and order placed for the service during the property walkthrough.

17. An integrated method for simplying real estate transaction during a preparation of a property for listing, the method comprising
preparing a checklist for a list of actions for an inspection of the property;
performing a property walkthrough for the inspection of the property;
going over the checklist during the property walkthrough; and
generating orders for property-related tasks during the property walkthrough using existing vendor profiles.

18. A method as in claim 1 wherein the checklist comprising a set of predetermined templates for suggesting a course of actions for the inspection of the property.

19. A method as in claim 1 further comprising a step of inputting to the checklist a condition of the property during the property walkthrough to get a suggestion of a series of actions.

20. A method as in claim 1 further comprising a preparing step of practicing through blank walkthrough forms, thrpugh samples of completed walkthrough, or through detailed instruction of how to use the walkthrough forms.
